(19) United States
(12) Patent Application Publication
(10) Pub. No.: US 2017/0364060 A1
(43) Pub. Date: Dec. 21, 2017

(54) SYSTEM AND METHOD FOR IDENTIFYING AND MANAGING DEFECTS IN INDUSTRIAL PROCESS CONTROL AND AUTOMATION SYSTEMS

(71) Applicant: Honeywell International, Inc., Morris Plains, NJ (US)

(72) Inventors: Abhishek Nikhra, Bangalore (IN); Manas Dutta, Bangalore (IN); Ramakrishnan Ganapathi, Bangalore (IN)

(21) Appl. No.: 15/188,848

(22) Filed: Jun. 21, 2016

(51) Int. Cl. G05B 19/418

(52) U.S. Cl. CPC G05B 19/4184; G05B 2219/31368

(57) ABSTRACT

A method includes applying a defect rule to engineering configurations in an industrial process control and automation system. This includes extracting query logic from the defect rule defining a defect. This also includes executing the extracted query logic on the engineering configurations. This further includes storing results of the executed query logic as an identified defect. The method could also include reconciling the identified defect by comparing the results of the executed query logic for a current iteration with results of the executed query logic from previous iterations and determining a current state of the identified defect based on the comparison.

### TECHNICAL FIELD

This disclosure is generally directed to industrial process control and automation systems. More specifically, this disclosure is directed to a system and method for identifying and managing defects in industrial process control and automation systems.

### BACKGROUND

A manufacturing plant or other industrial facility often has multiple distributed control systems (DCSs), programmable logic controllers (PLCs), safety systems, or applications for controlling different processes. Each of these systems typically has an engineering configuration for its functions. Any incorrect or invalid engineering configuration may lead to losses, unpredictable results, unplanned shutdowns, catastrophic damage, or loss of life.

### SUMMARY

This disclosure provides a system and method for identifying and managing defects in industrial process control and automation systems.

In a first example, a method includes applying a defect rule to engineering configurations in an industrial process control and automation system. This includes extracting query logic from the defect rule defining a defect. This also includes executing the extracted query logic on the engineering configurations. This further includes storing results of the executed query logic as an identified defect.

In a second example, an apparatus includes at least one memory and at least one processor configured to apply a defect rule to engineering configurations in an industrial process control and automation system. The at least one processor is configured to extract query logic from the defect rule defining a defect. The at least one processor is also configured to execute the extracted query logic on the engineering configurations. The at least one processor is further configured to store results of the executed query logic as an identified defect in the at least one memory.

In a third example, a non-transitory computer readable medium embodies a computer program. The computer program includes a computer readable program code that, when executed by processing circuitry, causes the processing circuitry to apply a defect rule to engineering configurations in an industrial process control and automation system. This includes extracting query logic from the defect rule defining a defect. This also includes executing the extracted query logic on the engineering configurations. This further includes storing results of the executed query logic as an identified defect.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example industrial process control and automation system according to this disclosure;

FIG. 2 illustrates an example device supporting defect identification and management in an industrial process control and automation system according to this disclosure; and

FIG. 3 illustrates an example method for identifying and managing defects in an industrial process control and automation system according to this disclosure.

### DETAILED DESCRIPTION

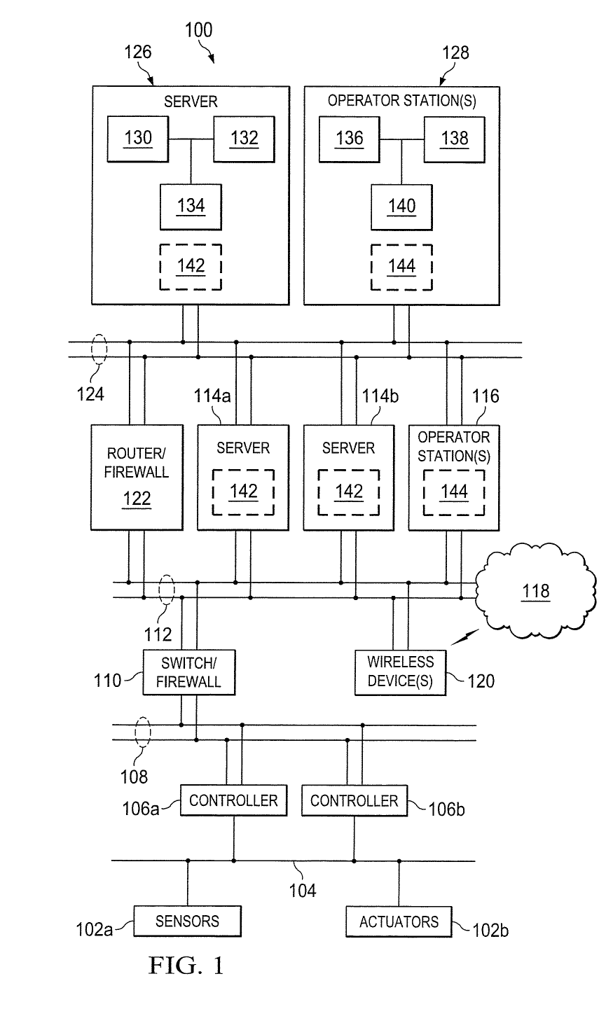

FIGS. 1 through 3, discussed below, and the various examples used to describe the principles of the present disclosure in this patent document are by way of illustration only and should not be construed in any way to limit the scope of the disclosure. Those skilled in the art will understand that the principles of the present disclosure may be implemented in any suitable manner and in any type of suitably arranged device or system.

FIG. 1 illustrates an example industrial process control and automation system 100 according to this disclosure. In this example, the system 100 includes various components that facilitate production or processing of at least one product or other material. The system 100 here includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. The actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system. Also, a process system may generally represent any system or portion thereof configured to process one or more products or other materials in some manner.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

Two controllers 106a-106b are coupled to the network 104. The controllers 106a-106b may, among other things, use the measurements from the sensors 102a to control the operation of the actuators 102b. For example, the controllers 106a-106b could receive measurement data from the sensors 102a and use the measurement data to generate control signals for the actuators 102b. Each of the controllers 106a-106b includes any suitable structure for interacting with the sensors 102a and controlling the actuators 102b. The controllers 106a-106b could, for example, represent multivariable controllers or other types of controllers. As a particular example, each of the controllers 106a-106b could represent a computing device running a real-time operating system. In some embodiment, the controllers 106a-106b could denote a redundant pair of controllers.

Two networks 108 are coupled to the controllers 106a-106b. The networks 108 facilitate interaction with the controllers 106a-106b, such as by transporting data to and from the controllers 106a-106b. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

Two servers 114a-114b are coupled to the networks 112. The servers 114a-114b perform various functions to support the operation and control of the controllers 106a-106b, sensors 102a, and actuators 102b. For example, the servers 114a-114b could log information collected or generated by the controllers 106a-106b, such as measurement data from the sensors 102a or control signals for the actuators 102b. The servers 114a-114b could also execute applications that control the operation of the controllers 106a-106b , thereby controlling the operation of the actuators 102b. In addition, the servers 114a-114b could provide secure access to the controllers 106a-106b. Each of the servers 114a-114b includes any suitable structure for providing access to, control of, or operations related to the controllers 106a-106b. Each of the servers 114a-114b could, for example, represent a computing device running a MICROSOFT WINDOWS operating system.

One or more operator stations 116 are coupled to the networks 112. The operator stations 116 represent computing or communication devices providing user access to the servers 114a-114b, which could then provide user access to the controllers 106a-106b (and possibly the sensors 102a and actuators 102b). As particular examples, the operator stations 116 could allow users to review the operational history of the sensors 102a and actuators 102b using information collected by the controllers 106a-106b and/or the servers 114a-114b . The operator stations 116 could also allow the users to adjust the operation of the sensors 102a , actuators 102b , controllers 106a-106b, or servers 114a-114b. In addition, the operator stations 116 could receive and display warnings, alerts, or other messages or displays generated by the controllers 106a-106b or the servers 114a-114b. Each of the operator stations 116 includes any suitable structure for supporting user access and control of the system 100. Each of the operator stations 116 could, for example, represent a computing device running a MICROSOFT WINDOWS operating system.

In this example, the system 100 also includes a wireless network 118, which can be used to facilitate communication with one or more wireless devices 120. The wireless network 118 may use any suitable technology to communicate, such as radio frequency (RF) signals. Also, the wireless devices 120 could represent devices that perform any suitable functions. The wireless devices 120 could, for example, represent wireless sensors, wireless actuators, and remote or portable operator stations or other user devices.

At least one router/firewall 122 couples the networks 112 to two networks 124. The router/firewall 122 includes any suitable structure for providing communication between networks, such as a secure router or combination router/firewall. The networks 124 could represent any suitable networks, such as a pair of Ethernet networks or an FTE network.

In this example, the system 100 includes at least one additional server 126 coupled to the networks 124. The server 126 executes various applications to control the overall operation of the system 100. For example, the system 100 could be used in a processing plant or other facility, and the server 126 could execute applications used to control the plant or other facility. As particular examples, the server 126 could execute applications such as enterprise resource planning (ERP), manufacturing execution system (MES), or any other or additional plant or process control applications. The server 126 includes any suitable structure for controlling the overall operation of the system 100.

One or more operator stations 128 are coupled to the networks 124. The operator stations 128 represent computing or communication devices providing, for example, user access to the servers 114a-114b, 126. Each of the operator stations 128 includes any suitable structure for supporting user access and control of the system 100. Each of the operator stations 128 could, for example, represent a computing device running a MICROSOFT WINDOWS operating system.

In particular embodiments, the various servers and operator stations may represent computing devices. For example, each of the servers 114a-114b, 126 could include one or more processors 130 and one or more memories 132 for storing instructions and data used, generated, or collected by the processor(s) 130. Each of the servers 114a-114b, 126 could also include at least one network interface 134, such as one or more Ethernet interfaces. Also, each of the operator stations 116, 128 could include one or more processors 136 and one or more memories 138 for storing instructions and data used, generated, or collected by the processor(s) 136. Each of the operator stations 116, 128 could also include at least one network interface 140, such as one or more Ethernet interfaces.

As noted above, various devices in an industrial process control and automation system can have different engineering configurations. Any incorrect or invalid engineering configuration may lead to various problems in the system. For example, certain defects can exist in a control and instrumentation (C&I) system configuration of a manufacturing or process plant. As a particular example of a defect, the C&I system configuration could include a tag representing a level of fluid in a column or tank, and the C&I system configuration could allow different devices or connections to write a value of the tag. This can be considered as a defect since the different devices or connections could write different values for the tag. As another particular example of a naming error defying the convention, an invalid configuration can exist when a system enforces syntactic rules on entity names or on variable names and does not enforce naming conventions, which may result in a defect for violation of naming conventions. As still other particular examples, an invalid configuration can occur when a C&I system does not enforce validation rules for invalid engineering configurations and when best practices suggested by the C&I system are not followed. Since these defects are not based on policies of a plant owner and are not based on a specific C&I system (such as a vendor-specific C&I system), these defects can be considered as generic types defects.

Other types of defects can exist in a C&I system configuration when guidelines and policies set by an owner of a plant are not followed. For example, an invalid configuration can occur as a result of deviation from guidelines and processes followed by an organization that owns a plant. As another example, an invalid configuration can occur when interconnections between systems of a plant are not validated by participating systems, such as when one participating system allows deletion of a tag that is being referenced by another participating system.

This disclosure provides a defect management system that collects and stores engineering configurations for different C&I systems or other systems installed in a plant, such as C&I systems from different vendors or from different platforms. The defects noted above happened because a C&I system did not check the engineering configurations, did not prevented or stopped these defects, and allowed incorrect configurations (and consequential problems) to occur. The defect management system of this disclosure checks engineering configurations to identify, flag, remove, and prevent defects (and consequential problems). For example, one or more of the servers 114a-114b, 126 could include a defect management tool 142 used to identify and manage defects in engineering configurations of C&I systems or other systems. That is, one or more of the servers 1141-114b has the ability to identify defects in the engineering configuration of other systems. In some embodiments, the defect management tool 142 includes a rule-based engine (referred to as a “defect engine”) to identify incorrect or invalid engineering configurations and report them as defects. The defect engine can record timestamps (such as dates and times) when defects are identified and the C&I or other systems in which the defects are found. The defect engine also has the ability to match identified defects with already-recorded defects from previous runs of a defect identification process. This matching indicates whether the same defect or a new defect has been found and can be used to identify if a defect that was previously identified as having been closed is found again or otherwise reopened. In particular embodiments, the defect management tool 142 can perform orthogonal analysis of defects and defect reduction.

As described in more detail below, the tool 142 can implement a defect identification process shown in FIG. 3. In particular embodiments, the tool 142 includes a suitable application for identifying defects in C&I or other system configurations, updating and storing defect definitions, and generating graphical displays that represent defect reconciliation results of currently-identified defects or previously-found defects.

The tool 142 includes any suitable structure for identifying and managing defects in engineering configurations in an industrial process control and automation system. As a specific non-limiting example, the tool 142 can include any suitable structure for identifying and managing defects in engineering configurations for devices, process controllers, logic, ladder logic, HMI displays, connections, and the like in the industrial process control and automation system. For example, the tool 142 could denote one or more software routines or other software code executed by one or more processors. While shown as being incorporated into the servers 114a-114b, 126, the tool 142 could be used with other systems or devices. For example, the tool could be incorporated into the operator stations 116, 128.

The operator stations 116, 128 may include or support one or more human-machine interface (HMI) applications 144. An HMI application 144 generally represents an application that generates graphical displays for presenting content to operators. For example, the graphical displays could visually represent one or more processes (or portions thereof) being monitored and/or controlled by the operators. An HMI application 144 can present any suitable graphical data to an operator. Each HMI application 144 includes any suitable application for generating graphical displays. As a particular example, the HMI application 144 could use HMIWEB technology from HONEYWELL INTERNATIONAL INC. The HMIWEB technology uses hypertext markup language (HTML) and allows users to build process control displays (web pages) that are loaded onto operator stations 116, 128. The HTML displays may use INTERNET EXPLORER or other browser technology to extend the functionality of the web pages to allow process information to be displayed and to allow operators to control processes via the web pages. In particular embodiments, the HMI application 144 can operate within a larger system, such as within EXPERION systems from HONEYWELL INTERNATIONAL INC.

In some embodiments, the HMI application 144 incorporates features of a user interface provided by the tool 142. For example, the tool 142 could provide a user interface that shows an area of work or a system affected by identified defects in a C&I or other system. The user interface provided by the tool 142 allows personnel, such as engineers or maintenance operators, to see the current states of defects and to generate change requests to address the identified defects. The defect management tool 142 can also associate change request identifications (IDs) with identified defects. For example, a change request can include a change request ID linked to an identification of a particular defect. Through the change request, personnel can change the state of a defect by inputting an open state, closed state, or suppressed state of the defect.

In some embodiments, the user interface provided by the tool 142 can display a list of defects and information from a report associated with the listed defects. The tool 142 also has the ability receive user input to add appropriate comments (such as those associated with actions like assignment, suppression, or state change) for the defect. For example, the user interface of the tool 142 can enable personnel to input information like comments and to link the information to a particular defect and/or its corresponding change request. The tool 142 can thereby enable the defect management system to receive and store user input assigning a defect to personnel for resolution and to resolve and track the assignment and actions performed to resolve the defect. The defect management system can therefore associate an identified defect with changes that were implemented to address the defect. As an example, when a personnel member logs in to the tool 142, the tool 142 can provide a notification, such as a visual display or audio indicator in the operator station 116, 128, of each defect that has been assigned to that personnel member.

The defect management tool 142 provides a flexible rule-based defect identification system in which rules can be added, modified, or deleted. As such, in some embodiments, the user interface provided by the tool 142 enables personnel to create, modify, or delete user-defined defect rules. For example, the user interface provided by the tool 142 can receive and store user input providing a definition of a defect that could be found in an engineering configuration of a specific C&I or other system or found in an engineering configuration of a variety of C&I or other systems. As a particular example, personnel can create a user-defined defect rule to find all network switches of a certain model (such as an obsolete model number) and indicate each as a defect. This rule would enable personnel to quickly identify which portion of an engineering configuration (shown in FIG. 3) is no longer supported by a vendor. As another example, the defect management system could find defects applicable to a specific tag and/or system.

Although FIG. 1 illustrates one example of an industrial process control and automation system 100, various changes may be made to FIG. 1. For example, a system could include any number of sensors, actuators, controllers, servers, operator stations, networks, tools, and HMI applications. Also, the makeup and arrangement of the system 100 in FIG. 1 is for illustration only. Components could be added, omitted, combined, or placed in any other suitable configuration according to particular needs. In addition, FIG. 1 illustrates one operational environment in which a tool for identifying and managing defects in industrial process control and automation systems can be used. This functionality could be used in any other suitable device or system. As another example, in the industrial process control and automation system 100, the defect management system could be divided in two parts: (i) a tool or application, which can be implemented in an operator station 116, 128; and (ii) a rule based engine, which can be implemented in a server 114a-114b, 126. That is, the server 114a-114b, 126 implements one part of the defect management tool 142, namely, the rule based engine part that when executed, analyzes the engineering configuration and identifies defects. Also in such embodiments, the operator station 116, 128 implements the other part of the defect management tool 142 (e.g., that part which could be incorporated in the HMI application 144), namely, the part that when executed, provides a user interface to the user of the defect management system, provides the capability to visually display the defects for a user to see, take actions on the defects, and defines new defects according to user selections.

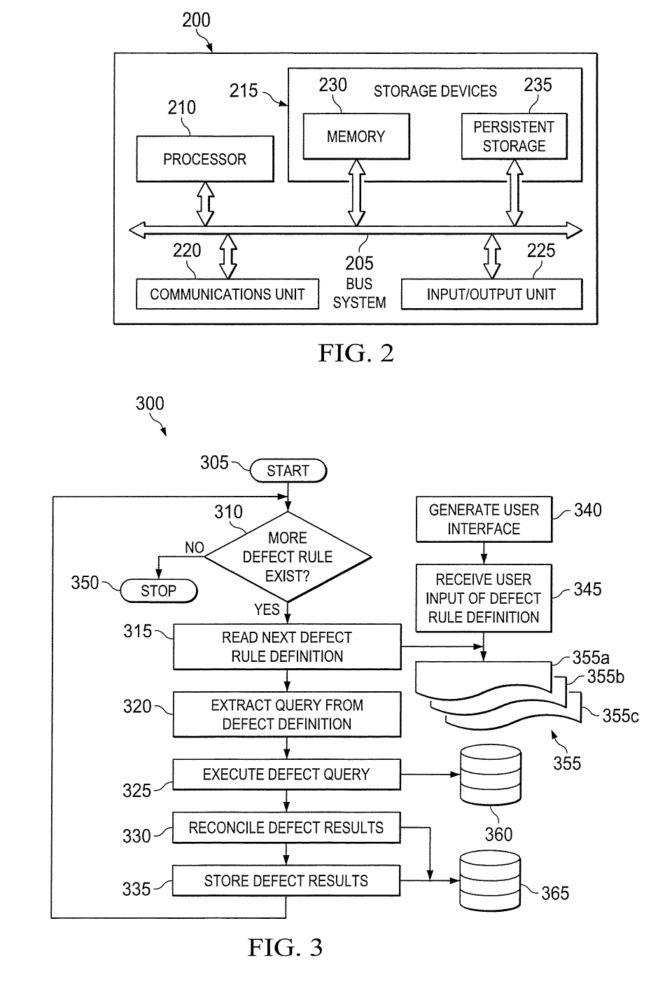

FIG. 2 illustrates an example device 200 supporting defect identification and management in an industrial process control and automation system according to this disclosure. The device 200 could, for example, represent a server 114a, 114b, 126 or other computing device executing or otherwise supporting or providing the tool 142.

As shown in FIG. 2, the device 200 includes a bus system 205, which supports communication between at least one processor 210, at least one storage device 215, at least one communications unit 220, and at least one input/output (I/O) unit 225. The processor 210 executes instructions that may be loaded into a memory 230. The processor 210 may include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random access memory or any other suitable volatile or non-volatile storage device(s). The persistent storage 235 may contain one or more components or devices supporting longer-term storage of data, such as a read only memory, hard drive, Flash memory, or optical disc.

The communications unit 220 supports communications with other systems or devices. For example, the communications unit 220 could include a network interface card or a wireless transceiver facilitating communications over the network 112, 124. The communications unit 220 may support communications through any suitable physical or wireless communication link(s). More particularly, the communications unit 220 could include a transmitter and a receiver for communicating with external devices.

The I/O unit 225 allows for input and output of data. For example, the I/O unit 225 may provide a connection for user input through a keyboard, mouse, keypad, touchscreen, or other suitable input device. The I/O unit 225 may also send output to a display, printer, or other suitable output device.

Although FIG. 2 illustrates one example of a device 200 supporting defect identification and management in an industrial process control and automation system, various changes may be made to FIG. 2. For example, computing devices come in a wide variety of configurations. The device 200 shown in FIG. 2 is meant to illustrate one example type of computing device and does not limit this disclosure to a particular type of computing device.

FIG. 3 illustrates an example method 300 for identifying and managing defects in an industrial process control and automation system according to this disclosure. For ease of explanation, the method 300 is described with respect to the defect management tool 142 of FIG. 1. However, the method 300 could be used by any suitable device and in any suitable system. For example, defects can be identified on various elements of the C&I system, including elements such as a device, process controller, logic, ladder logic, HMI display, connections, and the like.

In some embodiments, the method 300 can denote an offline process that begins in response to user input selecting execution of the method 300 or in response to a determination that a previously-selected start time matches a current time. For example, the user could gesture or manually press a button indicating a desire for the method 300 to be executed. As another example, the defect management system could execute the method 300 periodically according to a schedule, such as every Monday at 9 o'clock in the morning. Although the method 300 will be described as an offline process that does not continually collect data, this disclosure is not limited to offline implementations and could include an online implementation, such as one that continually collects data as a plant operates and starts a new iteration of the method 300 after completion of each iteration.

The method 300 commences at step 305, such as in response to user input or upon a predefined time or event. The method 300 then iterates steps 310-335 over each of multiple defect rules 355a-355c stored in a “defect definitions” storage 355. In some embodiments, the storage 355 includes a defect rule defining each of the defects to be detected, such as those described above. In particular embodiments, a defect rule can define a defect and include a user-friendly description of that defect. The defect rule can also include logic used to identify the defect and information that is collected to identify the defect. The defect rule can further include information specifying whether the defect is specific to a particular control system or if the defect is a generic rule applicable to different control systems. A defect rule could define a defect as an instance wherein an engineering configuration does not meet a syntactic rule or naming convention, or does not meet best practices of the C&I system, or does not meet guidelines and policies set by an owner of a plant. The storage 355 can also store information regarding whether a defect rule is system-defined or is user-defined or custom. A system-defined rule can denote a pre-built rule in a defect management system. A user-defined rule can denote a rule defined by a user, such as one based on engineering practices and policies of an owner of a plant, which may be modified over time. A generic defect rule can be a system-defined or user-defined, and a system-specific defect rule can be system-defined or user-defined. The defect rules 355a-355c can include generic defect rules and system-specific (such as vendor-specific) defect rules. The storage 355 can also store information regarding a classification of respective defect rules 355a-355c, and the classifications can be based on various criteria.

At step 310, the tool 142 determines whether the method 300 has been executed for each defect rule in the storage 355. If so, the method 300 ends at step 350. Otherwise, the tool 142 selects the next rule 355a-355c in the storage 355 at step 315. At step 320, the tool 142 extracts a query from the selected defect rule, such as by extracting logic of the query. An example query could be to identify each tag for which multiple devices or connections are configured to write a value for the tag. Another example query could be to identify each of multiple devices or connections configured to write a tag value to the same tag.

At step 325, the tool 142 executes the extracted defect query on configurations in an “engineering configurations” storage 360 or otherwise applies the logic of the extracted defect query to the configurations in the storage 360. In some embodiments, the engineering configurations storage 360 denotes a documentation system that collects and stores engineering configurations for different C&I systems or other systems installed in a plant. The engineering configurations storage 360 can store engineering configurations for various specific C&I or other systems, such as from different vendors. The results of the execution of the extracted defect query could include an identification of a defect, a timestamp of when the defect is identified, and an identification of the specific control system having the defect. As an example, the results of the execution of the extracted defect query could include an impact classification of a defect, indicating whether the defect has a low impact, moderate impact, or severe impact on the system 100. For example, the impact classification of a defect can be determined based on a severity of the effect that the defect has or could have on the system 100. The impact classification of a defect could be the same as the impact classification of the defect rule applied to identify the defect. That is, the storage 355 can store information regarding an impact classification of respective defect rules 355a-355c.

Defect results are reconciled at step 330. For example, the tool 142 can match identified defects against defects already recorded in a “defects” storage 365 from one or more previous iterations. As a specific example, the tool 142 can compare (i) the results of the current execution of the defect query extracted from one defect rule with (ii) the results of one or more previous executions of the defect queries extracted from other defect rules. Based on the comparison and any matches, the tool 142 can identify that the same defect is found again (a recurring defect), that a new defect is found, that the defect already existed and is not found anymore, or that the defect was previously closed and is again found (a reopened defect). The tool 142 can identify the current state of an identified defect as being an open state when a new defect is found or when a recurring defect that is not suppressed is found, a suppressed state when a recurring defect subjected to a suppression is found during the suppression period, or a re-opened state when a reopened defect is found. In some embodiments, the defect management tool 142 also maintains identification of the state (such as open state, closed state, or reopen state) for previous runs. The defect management tool 142 can reconcile the identified defect if the defect is not found in the latest iteration of the method 300. Reconciliation enables personnel to add details regarding how the defect was really addressed, such as via a thin client implementation at an operator station 116, 128 accessing an associated change request through the user interface provided by the tool 142.

In certain embodiments, the current state of the identified defect could additionally indicate progress of the work fixing the identified defect. The results of the execution of the extracted defect query could include a change request linked to an identified defect. The tool 142 can compare a change request associated with the identified defect against change requests associated with defects already recorded in the “defects” storage 365 from one or more previous iterations. Based on the any matching change requests found from the comparison, the tool 142 can determine progress of the work removing or otherwise addressing the identified defect, such as a completion amount of assigned work or a remaining amount of incomplete work. This tracking of the assignment and actions performed to resolve the defect enables the defect management system to associate an identified defect with a current state of its associated change request(s).

Current defect results are stored at step 335. For example, the tool 142 can update the defect storage 365 with the newest defect information and with a state of the newest identified defect (collectively referred to as a report). By storing the resulting defect information and associated state of the identified defect for each iteration of the method 300, the storage 365 accumulates an audit trail of historical data for each defect found. In addition to the identified defect, the report from the tool 142 could provide a set of information that helps one to understand the root cause of the defect and the tag on which the defect has been identified. In some embodiments, a report from the tool 142 can include suggestions about how to resolve the identified defect and why the defect has been caused.

Each storage 355-365 represents at least one data storage and retrieval device configured to store the described information. While shown as three separate storages, the data in the storages 355-365 could be combined or divided in any suitable manner.

As shown in FIG. 3, the tool 142 generates a user interface for display at step 340 and receives user input at step 345. These steps allow the tool 142 to receive user input defining at least some of the defect rules 355a-355c contained in the storage 355 and that are used during the iterations. This user interface allows the tool 142 to receive user input defining one or more user-defined defects.

Although FIG. 3 illustrates one example of a method 300 for identifying and managing defects in an industrial process control and automation system, various changes may be made to FIG. 3. For example, various steps in FIG. 3 could overlap, occur in parallel, occur in a different order, or occur any number of times.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in this patent document should not be read as implying that any particular element, step, or function is an essential or critical element that must be included in the claim scope. Also, none of the claims is intended to invoke 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed:

1. A method comprising:
applying a defect rule to engineering configurations in an industrial process control and automation system by:
extracting query logic from the defect rule defining a defect;
executing the extracted query logic on the engineering configurations; and
storing results of the executed query logic as an identified defect.

2. The method of claim 1, further comprising determining an impact classification of the identified defect based on an effect that the identified defect has on the industrial process control and automation system; and
reconciling the identified defect by:
comparing the results of the executed query logic for a current iteration with results of the executed query logic from previous iterations, and
determining a current state of the identified defect based on the comparison, wherein the current state includes an indicator of progress of work for fixing the identified defect.

3. The method of claim 1, further comprising:
applying multiple defect rules to the engineering configurations; and
storing results corresponding to multiple identified defects, the results including a timestamp when each defect is identified and an identification of a control system having the defect.

4. The method of claim 1, wherein:
multiple defect rules include at least one system-defined defect rule and at least one user-defined defect rule; and
the method further comprises:
generating a user interface; and
receiving, through the user interface, input providing at least one definition of the at least one user-defined defect rule.

5. The method of claim 1, wherein the defect rule comprises a generic defect rule applicable to multiple control systems.

6. The method of claim 1, wherein the defect rule comprises a system-specific defect rule applicable to a single control system.

7. The method of claim 1, wherein the defect rule comprises a predefined defect rule.

8. The method of claim 1, wherein the defect rule comprises a user-defined defect rule.

9. An apparatus comprising:
at least one memory; and
at least one processor configured to apply a defect rule to engineering configurations in an industrial process control and automation system, the at least one processor configured to:
extract query logic from the defect rule defining a defect;
execute the extracted query logic on the engineering configurations; and
store results of the executed query logic as an identified defect in the at least one memory.

10. The apparatus of claim 9, wherein the at least one processor is further configured to:
determine an impact classification of the identified defect based on an effect that the identified defect has on the industrial process control and automation system; and
reconcile the identified defect by:
comparing the results of the executed query logic for a current iteration with results of the executed query logic from previous iterations, and
determining a current state of the identified defect based on the comparison, wherein the current state includes an indicator of progress of work for fixing the identified defect.

11. The apparatus of claim 9, wherein the at least one processor is further configured to:
apply multiple defect rules to the engineering configurations; and
store results corresponding to multiple identified defects, the results including a timestamp when each defect is identified and an identification of a control system having the defect.

12. The apparatus of claim 9, wherein:
multiple defect rules include at least one system-defined defect rule and at least one user-defined defect rule; and
the at least one processor is further configured to:
generate a user interface; and
receive, through the user interface, input providing at least one definition of the at least one user-defined defect rule.

13. The apparatus of claim 9, wherein the defect rule comprises one of: a generic defect rule applicable to multiple control systems and a system-specific defect rule applicable to a single control system.

14. The apparatus of claim 9, wherein the defect rule comprises one of: a predefined defect rule and a user-defined defect rule.

15. A non-transitory computer readable medium embodying a computer program, the computer program comprising computer readable program code that, when executed by processing circuitry, causes the processing circuitry to:
apply a defect rule to engineering configurations in an industrial process control and automation system by:
extracting query logic from the defect rule defining a defect;
executing the extracted query logic on the engineering configurations; and
storing results of the executed query logic as an identified defect.

16. The non-transitory computer readable medium of claim 15, wherein the computer program further comprises computer readable program code that, when executed by the processing circuitry, causes the processing circuitry to:
determine an impact classification of the identified defect based on an effect that the identified defect has on the industrial process control and automation system; and
reconcile the identified defect by:
comparing the results of the executed query logic for a current iteration with results of the executed query logic from previous iterations, and
determining a current state of the identified defect based on the comparison, wherein the current state includes an indicator of progress of work for fixing the identified defect.

17. The non-transitory computer readable medium of claim 15, wherein the computer program further comprises computer readable program code that, when executed by the processing circuitry, causes the processing circuitry to:
apply multiple defect rules to the engineering configurations; and
store results corresponding to multiple identified defects, the results including a timestamp when each defect is identified and an identification of a control system having the defect.

18. The non-transitory computer readable medium of claim 15, wherein:
multiple defect rules include at least one system-defined defect rule and at least one user-defined defect rule; and
the computer program further comprises computer readable program code that, when executed by the processing circuitry, causes the processing circuitry to:
generate a user interface; and
receive, through the user interface, input providing at least one definition of the at least one user-defined defect rule.

19. The non-transitory computer readable medium of claim 15, wherein the defect rule comprises one of: a generic defect rule applicable to multiple control systems and a system-specific defect rule applicable to a single control system.

20. The non-transitory computer readable medium of claim 15, wherein the defect rule comprises one of: a predefined defect rule and a user-defined defect rule.
